(19) United States
(12) Patent Application Publication
(10) Pub. No.: US 2003/0015075 A1
(43) Pub. Date: Jan. 23, 2003

(54) Arrangement for cutting products with a draw cut

(76) Inventor: Peter Merkli, Oftringen (CH)

Correspondence Address: VENABLE, BAETJER, HOWARD AND CIVILETTI, LLP, P.O. BOX 34385, WASHINGTON, DC, 20043-9998, US

(21) Appl. No.: 10/189,004

(22) Filed: Jul. 5, 2002

(30) Foreign Application Priority Data
Jul. 5, 2001 (EP) 01810665.8

(51) Int. Cl. B26D 7/14

(52) U.S. Cl. 83/23; 83/155; 83/175; 83/422; 83/431

(57) ABSTRACT

An arrangement for cutting products with the aid of a draw cut includes an upright cutting knife and a conveying device for moving the products in a conveying direction against the upright cutting knife. The conveying device includes at least one endless conveying element for holding and guiding the products during a cutting operation.

### CROSS-REFERENCE TO RELATED APPLICATION

This application claims the priority of European Patent Application No. 01810665.8 filed on Jul. 5, 2001, the disclosure of which is being incorporated herein by reference.

### BACKGROUND OF THE INVENTION

The invention relates to an arrangement for cutting products with the aid of a draw cut, for which the products are moved with the aid of a conveying means against an upright cutting knife.

An arrangement of the aforementioned type is disclosed in European Patent Application No. 0 670 203. In contrast to standard cutting arrangements, the cutting knife of the known arrangement is positioned immovably while the products to be cut move toward the cutting knife. The products are guided past the cutting knife and, in the process, are cut with a draw cut. The cutting forces for this are considerable and the products must be held and guided firmly during the cutting operation, so that a clean cut results. For the above-mentioned movement, the products to be cut are respectively secured with a clamp on a carriage. The carriages having respectively one clamped-on product are positioned on a guide rail and moved, as described in the above, wherein the cutting knife penetrates the product. The disadvantage of this arrangement is that a non-timed, continuous processing of products is not possible. In particular, a continuous cutting of a scaled flow of printed products is not possible. In order to process a scaled flow, the individual products would have to be secured individually on a carriage and cut in a timed operation.

### SUMMARY OF THE INVENTION

It is an object of the invention to create an arrangement of the aforementioned type, which also permits a non-timed cutting of products.

The above and other objects are accomplished according to the invention by the provision of an arrangement for cutting products with the aid of a draw cut, comprising: an upright cutting knife; and a conveying means for moving the products in a conveying direction against the upright cutting knife, wherein the conveying means includes at least one endless conveying element for holding and guiding the products during a cutting operation.

With the arrangement according to the invention, the conveying means is provided with at least one endless conveying element, with which the products are secured in place and are guided during the cutting operation. With a conveying element of this type, a scaled flow of, for example, printed products and in particular brochures, newspapers and the like can also be conveyed continuously and cut.

According to one modification of the invention, the products can be held and guided particularly easily if the cutting occurs on a curved track and if one of the conveying means is designed as a counter knife that rotates along. In that case, the product to be cut can be held without slipping and free of friction, even if subjected to a high cutting pressure.

It is advantageous if the counter knife simultaneously functions as an intake element and conveying element. The products to be cut are preferably conveyed between the aforementioned endless conveying element and the counter knife, wherein the products can be conveyed particularly reliably and held securely during the cutting operation if clamped between these two conveying elements. That is particularly true if the conveying element is an endless belt, an endless chain or an endless toothed belt.

According to another modification of the invention, the cutting knife, the conveying element and the counter knife together form one unit. If two such units are arranged at a distance to each other in a mirror-inverted arrangement, the arrangement is particularly suitable for cutting the top and bottom of printed products. The top and bottom cuts can then be carried out simultaneously in one station. The arrangement according to the invention is especially suitable for cutting printed products such as newspapers, paper stacks, brochures, books and the like. The printed products can be supplied at irregular intervals to the arrangement according to the invention, either individually or in a scaled flow, can be processed and can subsequently be removed, thus resulting in a very high cutting capacity.

According to a different modification of the invention, the distance between the aforementioned two units can be adjusted, thus permitting an adaptation to different format widths and allowing different format to be cut with the same arrangement. The adjustment is comparatively easy since only the distance between the units must be adjusted. The two counter knives should advantageously be positioned on the same axis, making it sufficient to move only one unit for the adjustment.

Additional advantageous features will become apparent from the following detailed description considered in conjunction with the accompanying drawings.

### BRIEF DESCRIPTION OF THE DRAWINGS

FIG. 1 is a schematic view of an arrangement according to the invention.

FIG. 2 is a schematic view of a section along the line II-II in FIG. 1.

FIG. 3 is a schematic view showing a chip being cut off by the cutting arrangement according to the invention.

### DETAILED DESCRIPTION OF THE INVENTION

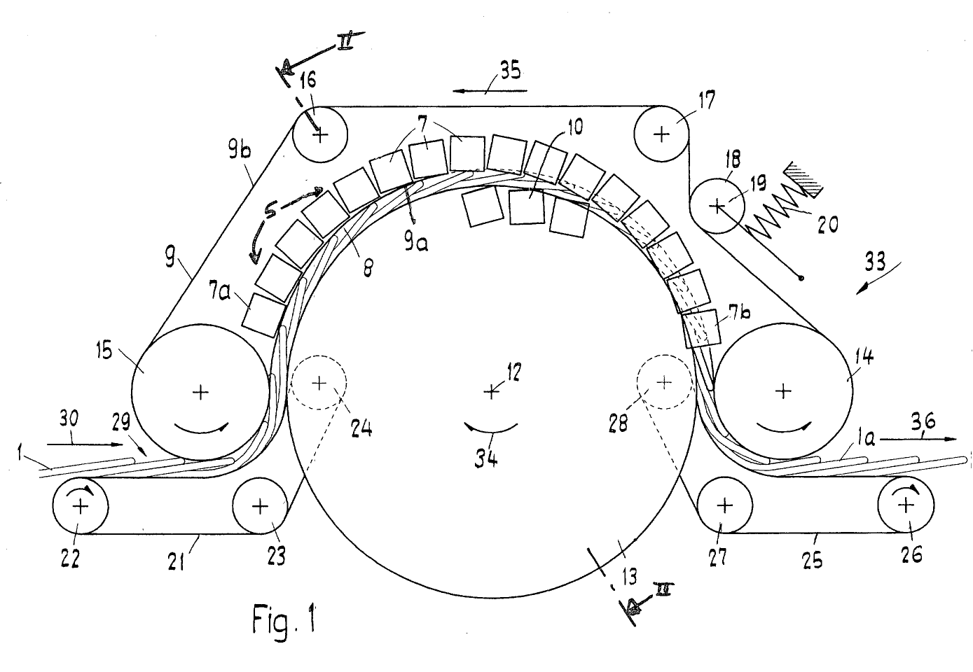

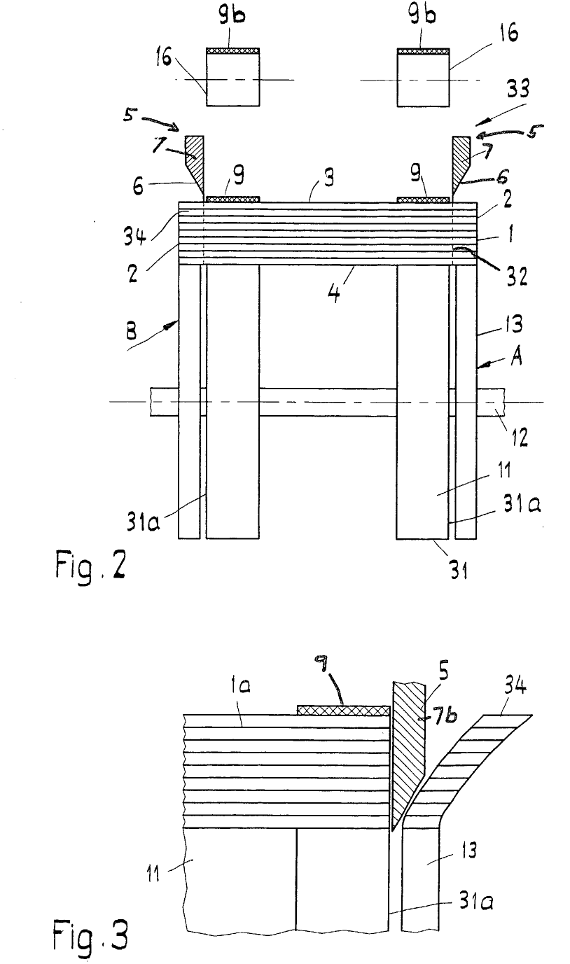

Referring to FIGS. 1 and 2, there is shown a cutting arrangement 33 according to the invention comprising two units A and B, each consisting essentially of a cutting knife 5 and the endless conveying elements 9, 11. The conveying element 11 also preferably comprises a counter knife. The two units A and B are positioned at a distance to each other on an axis 12, as shown in FIG. 2. At least one of the two units A and B can be adjusted in a direction along the axis 12 for increasing or reducing the spacing between the two units A and B.

Each cutting knife 5 consists of a plurality of flat blades 7 with respectively one cutting edge 6, which blades form a tapered cutting gap 8 together with the peripheral surface 31 of a counter knife 11, as shown in FIG. 1. This cutting gap 8 is largest at a first blade 7a and decreases steadily in the direction toward a blade 7b at the back end of the cutting knife 5. The blades 7 are connected rigidly, but such that they can be replaced, to a knife carrier and together form the rigidly frame-mounted cutting knife 5. In principle, the cutting knife 5 could also be produced as a single unit, but this would increase the production costs considerably. Furthermore, it is easier to re-sharpen individual blades 7. As can be seen, the cutting knife 5 has an approximately circular-arc shape.

The counter knife 11 is positioned rotating on the axis 12 or is designed to be locally secured thereon. In the first case, counter knife 11 forms a circular disc, with its circumferential surface 31, which is coaxial to the axis 12, as shown in FIG. 2. The spacing between the two counter knives 11 is adapted to the format of product 1. The products 1 are respectively pressed with one underside 4 against the circumferential surfaces 31 of the two counter knives 11. A disc 13 or guide is preferably concentrically arranged on the outside of each counter knife and is locally fixed or rotates along axis 12. This disc or guide functions to support a chip 34, that is cut off and removed, as shown in FIG. 3.

It is understood that the products to be cut are, or can be, aligned in a manner known, per se, on the side, in a station not shown herein, before they are supplied to the cutting station.

The conveying elements 9 can be endless belts, endless chains, toothed belts or the like, which are guided and tensioned in a manner known, per se. As shown in FIG. 1, the conveying elements 9 are guided with a lower belt run 9a at an angle of approximately 180° around the counter knives 11. The arrow 35 in FIG. 1 indicates the direction in which the parallel guided conveying elements 9 move. The upper belt run 9b in FIG. 1 thus moves from the right to the left and the lower belt run 9a moves from the left to the right. The conveying elements 9 cooperate in the region of a comparably large reversing roller 15 with a feed belt 21, which is fitted around guide rollers 22, 23 and 24. The reversing roller 15, the conveying elements 9 and the feed belt 21 jointly form a single intake area, indicated with arrow 30, where the products 1 to be cut are fed into the cutting gap 8. The products 1 form a scaled flow 29, for example, wherein the products 1 can include brochures, newspapers or other printed products.

A drive roller 14, arranged at a discharge area to the right in FIG. 1, can be used, for example, to drive the conveying elements 9. A discharge belt 25, which is fitted around guide rollers 26, 27 and 28, cooperates with conveying elements 9 in the region of drive roller 14 to discharge cut products 1a in the direction of arrow 36. A tensioning station 18 is arranged in an upward direction following the drive roller 14 and comprises two tensioning rollers 17 and 18, as well as a tensioning spring 20. Tensioning stations 18 of this type are well known to the person skilled in the art. An additional deflection roller 16 is arranged between the tensioning station 18 and the reversing roller 15.

The individual conveying elements 9 cooperate with a rotating counter knife 11 for conveying and guiding the printed products 1 to be cut in the region of the cutting knife 5. The lower belt run 9a is respectively tensioned against a counter knife 11, so that in the region of the cutting knife 5, the printed products 1 are secured while clamped between the two conveying elements 9 and the two counter knives 11.

The conveying speed of the two conveying elements 9 is adapted to the conveying speed of the two counter knives 11. Downstream of the reversing roller 15, the products 1 are fed into the cutting gap 8 with the aid of the two conveying elements 9 and the counter knives 11 and are carried along over the complete cutting range of cutting knife 5. As mentioned above, the cutting gap 8 is tapered in the conveying direction. The cutting edges 6 of the respective cutting blades 7 penetrate the products 1 from the product top 3 and, in the process, cut off respectively one chip 34 on the side, along a cutting line 32 as shown in FIG. 2. During the cutting operation, the cutting knives 5 respectively cooperate with a cutting edge 31a of a counter knife 11. These cutting edges 31a are circular and are respectively arranged along the outside of the counter knife 11. The cutting operation is completed and the two chips 34 are completely cut off upon reaching the blades 7b arranged on the ends, as shown in FIG. 3. The cut-off chips 34 drop down onto respectively one disc 13 that rotates along and removes these chips. At the same time, the rotating-along disc 13 supports the chips 34 and also helps cut the product completely. The cut printed products la are removed in the region of drive roller 14 and are supplied to additional processing devices that are not shown herein.

During the cutting operation, the printed products 1 can simultaneously be cut from the underside 4 with the aid of locally secured cutting knives 10 as shown in FIG. 1, which cut from the inside. This operation is particularly advantageous with extremely thin covers for the products 1. According to FIG. 1, the cutting knives 10 that are effective on the inside can extend over a partial region of the cutting knife 5 or over the complete region. The cutting knives that cut from the inside preferably also comprise several blades. Each cutting knife 5 can in principle be replaced with a cutting knife 5 that cuts from the inside. In that case, the printed products 1 are cut from the underside 4. A design provided with only one unit A or B and where only one of the two sides 2 is cut is conceivable as well. In principle, a frontal and/or a back cut of a printed product is also possible with the arrangement 33 according to the invention. A frontal cut could be realized in an additional station that is connected upstream or downstream and is not shown in further detail herein.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. An arrangement for cutting products with the aid of a draw cut, comprising:
an stationary cutting knife;
a conveying means for moving the products in a conveying direction against the stationary cutting knife, wherein the conveying means includes at least one endless conveying element for holding and guiding the products during a cutting operation.

2. The arrangement according to claim 1, further comprising a rotating counter knife operating jointly with the upright cutting knife during a cutting operation.

3. The arrangement according to claim 2, wherein the rotating counter knife comprises a disc that rotates along with the endless conveying element.

4. The arrangement according to claim 2, wherein the rotating counter knife includes a circular cutting edge.

5. The arrangement according to claim 2, further comprising at least one disc or guide arranged outside of the rotating counter knife for supporting a chip to be cut off of the product.

6. The arrangement according to claim 2, wherein the conveying element and rotating counter knife are arranged so that the products to be cut are clamped between the conveying element and the rotating counter knife.

7. The arrangement according to claim 6, wherein the conveying element and a peripheral surface of the conveying means are arranged so that the products are clamped between the conveying element and the peripheral surface of the conveying means.

8. The arrangement according to claim 1, wherein the conveying element comprises one of an endless belt, an endless chain and an endless toothed belt.

9. The arrangement according to claim 6, further including means for tensioning the conveying element against a peripheral surface of the rotating counter knife.

10. The arrangement according to claim, wherein the cutting knife and the rotating counter knife form a tapered cutting gap into which the products to be cut are fed and in which the products are cut.

11. The arrangement according to claim 10, wherein the rotating cutting knife is arranged at a flat angle to the conveying direction for the products to be cut.

12. The arrangement according to claim 1, wherein the cutting knife is comprised of a plurality of blades, each blade has a cutting edge and the cutting edges of the blades are respectively slanted at an angle to the conveying direction.

13. The arrangement according to claim 1, wherein the cutting knife has a curved cutting edge.

14. The arrangement according to claim 1, wherein the cutting knife, the conveying element and the rotating counter knife are arranged to form a single unit.

15. The arrangement according to claim 14, wherein two of said units are arranged at a distance to each other and the products to be cut are cut with both units.

16. The arrangement according to claim 15, further including means for adjusting a spacing between the two units to a final format for the products.

17. A method for cutting printed products, including utilizing the arrangement according to claim 1.
